(19) United States
(12) Patent Application Publication
(10) Pub. No.: US 2005/0164024 A1
(43) Pub. Date: Jul. 28, 2005

(54) Rubber masking compound and methods of use

(76) Inventor: John E. Tadych, Franklin, WI (US)

Correspondence Address: WHYTE HIRSCHBOECK DUDEK S C, 555 EAST WELLS STREET, SUITE 1900, MILWAUKEE, WI, 53202, US

(21) Appl. No.: 10/762,663

(22) Filed: Jan. 22, 2004

(51) Int. Cl. B32B 25/04; B32B 25/12

(52) U.S. Cl. 428/492; 442/415

(57) ABSTRACT

Masking compounds are comprised of a vulcanized rubber latex, at least one filler and aqueous ammonia. The masking compounds dry to a removable elastic membrane. The masking compounds are usable for masking a variety of materials, for cleaning surfaces, and, in combination with a sheet, for isolating or dividing spaces.

### BACKGROUND OF THE INVENTION

This invention relates generally to protecting surfaces from undesired contact with a coating, and more specifically to methods and compounds for masking surfaces and isolating areas.

### BRIEF SUMMARY OF THE INVENTION

The invention is a rubber-based masking compound and methods of using the compound. In one preferred embodiment, the invention is a masking compound comprising a vulcanized rubber latex, at least one filler and aqueous ammonia.

In another preferred embodiment, the invention is a process for masking a surface. The process comprises the steps of: (i) applying a masking compound comprising a vulcanized rubber latex, at least one filler and aqueous ammonia to a surface to be masked; (ii) allowing the masking compound to dry and form an elastic rubber membrane, thereby forming a masked surface; (iii) applying a coating to a surface to be coated in the vicinity of the masked surface; and, (iv) removing the elastic rubber membrane from the substrate subsequent to coating the surface to be coated.

In still another preferred embodiment, the invention is a method of isolating a space. The method comprises the steps of: (i) providing a first space and a second space, wherein the first space and second space are connected by an opening having at least one edge; (ii) applying a masking compound along at least part of the edge of the opening or in close proximity to the opening; (iii) affixing a sheet to the masking compound such that the sheet covers the opening, thereby isolating the first space from the second space.

Another preferred embodiment of the invention is a method of dividing a space. The method comprises the steps of: (i) providing a first space, wherein the first space is at least partially defined by a first surface and an opposing second surface; (ii) applying a masking compound to at least part of the first surface; and, (iii) affixing a sheet to the masking compound such that the sheet forms an at least partial barrier, thereby dividing the first space into a second space and a third space.

In a further preferred embodiment, the invention is a process for cleaning a surface from dirt, encapsulating particulates, particles, adhesives and other unwanted matter, thus eliminating solvent washing, airborne contamination, dust and other pollutants. This process prevents the related particulates and/or fumes from entering and polluting the atmosphere (i.e., circuit board cleaning, etc.). The process comprises the steps of: (i) applying a masking compound comprising a vulcanized rubber latex, at least one filler and aqueous ammonia to a surface to be cleaned; (ii) allowing the masking compound to dry and form an elastic rubber membrane; and, (iii) removing the elastic rubber membrane from the surface.

The removal of decals and other adhesive attachments is also possible through the topical application of ABR Rubber Mask. Undesired decals and other adhesives are removable without damaging the underlying substrate. ABR Rubber Mask adheres to the undesired decal and can then be successfully removed through a manual force or pulling action.

### DETAILED DESCRIPTION OF THE INVENTION

The inventive masking compound is a removable latex-based coating designed to protect substrates from paint overspray, tuck pointing smears and cleaning detergents. The masking compound can also be used in combination with plastic sheeting to isolate an area or room. The compound typically comprises a rubbery polymer latex, a filler, ammonia and other additives.

The latex is an aqueous suspension of a rubber polymer. Suitable rubber polymers include natural rubber (polyisoprene). Synthetic rubbers may also be suitable, including sodium polysulfide, polychloroprene, butadiene-styrene copolymers, acrylonitrilebutadiene copolymers, ethylenepropylene-diene rubbers, synthetic polyisoprene, butyl rubber kraton rubber (copolymer of isobutylene and isoprene), polyacrylonitrile, silicone, epichlorohydrin and polyurethane. A preferred polymer is natural or synthetic polyisoprene. The rubber latex should be vulcanized prior to use in the masking compound. Vulcanization of rubber is well-known in the art and any suitable vulcanization process may be used. Alternatively, prevulcanized latexes are commercially available, for example, #2000 Compound, a prevulcanized natural latex available from Killian Latex, Inc. of Akron, Ohio.

The filler may be any material that provides the desired viscosity of the masking compound and extends the latex. Typically, the filler may be any of the various well-known fillers, extenders or, optionally, coloring pigments for paints, such as talc, barium carbonate, calcium carbonate, clays (e.g., kaolin or bentonite), silicon dioxide, aluminum oxide, magnesium oxide, iron oxide, sodium oxide, magnese oxide, barium sulphate, mica, titanium oxide, carbon black, iron red and lithopone, cellulose fiber, christolite fiber, Vansil Acicular Wollastonite, preferably kaolin. The amount of filler added to the masking compound is determined by the desired consistency of the compound. Preferably, the masking compound will have a consistency ranging from paint-like to paste-like (e.g., similar to dry wall mud such that the compound can be applied to vertical and horizontal surfaces without excessive dripping or running. Also, preferably, the masking compound will have a consistency suitable for application of the compound by spraying, or with a brush, roller or trowel. The greater the amount of filler used, the thicker the consistency of the masking compound. The amount of the filler is usually from up to about 70 wt %, preferably up to about 50 wt %, more preferably up to about 20 wt % based on the solid content of the masking compound.

The masking compound contains aqueous ammonia (NH₄OH) or other source of the ammonium ion. One function of the ammonia is to act as a cleaner of the substrate being masked by loosening particulates. The amount of ammonia in the masking compound is determined by the amount of cleaning capability desired. A suitable level of aqueous ammonia addition is about 2 wt % based on the total weight of the masking compound.

Other additives in the masking compound can include stabilizers, such as UV and light stabilizers. Some suitable stabilizers are Tinuvin 292, Tinuvin 1130, Tinuvin 1076, Tinuvin 5151, zinc oxide and titanium oxide available from Ciba Specialty Chemicals Corporation.

When the masking compound has a paint-like consistency, it can be made using standard latex paint mixing equipment, such as a Cowles mixer usable for materials such as spackle or dry wall mud.

Depending on the consistency, the rubber masking compound can be applied with a trowel, brush, roller, spray gun or caulk gun. The masking compound can be applied to vertical and overhead surfaces. When the masking compound dries, it forms an elastic rubber membrane over the surface to which it was applied. The elastic rubber membrane adheres to the surface but is removable with light to moderate force. In some embodiments, removal of the elastic membrane requires a force of about 5 to about 8 pounds.

The fluid nature of the masking compound allows the compound to conform to surface texture, cracks and pores in the substrate to which the compound is applied. As such, the compound will bond to the substrate surface regardless of the texture, form, surface tension, moisture content or porosity of the substrate. Examples of such substrates are brick, limestone ledges or stone exteriors. Additionally, the intimate contact between the masking compound and the surface prevents liquids (such as paint, water stain or other finishes) from flowing under the membrane and also prevents loosening of the membrane by wind, rain or freezing.

The rubber mask can be used to protect a surface from overspray, splattering, drips or smears. For example, the masking compound may be applied to a surface to be protected from inadvertent application of a coating material, e.g., protecting an adjacent surface during paint spraying. The mask can be applied in a thin coat that completely covers the surface to be protected. Next, the masking compound is allowed to dry. When the rubber mask dries it forms an elastic rubber membrane, which masks the surface. The coating, e.g., paint, can then be applied to the surface to be covered. After the adjacent coating operation is completed, the elastic rubber membrane is peeled, along with any overspray or splatters, from the protected substrate. Typically, the elastic membrane will peel off in one piece for easy removal.

The masking compound can also function as a poultice to clean the surface to which it is applied. As above, the masking compound is applied to a surface, preferably as a thin coat. The ammonia in the masking compound acts to loosen particulates on the surface and can also provide some bleaching action. When the mask dries, it again forms an elastic membrane. The elastic membrane can then be peeled from the surface. When the membrane is removed from the surface, many of the particles loosened by the masking compound will be attached to the membrane, thereby leaving the surface cleaner. As such, the masking compound is useful in situations where dry cleaning is necessary.

The rubber masking compound can also be used in combination with flexible sheets to isolate or define a space. An example of isolating a space would be to separate a room from the rest of a building by sealing off a doorway. Such isolation can be accomplished by applying the masking compound along at least part of the edge of the doorway or along the doorway wall in close proximity to the doorway opening. A sheet can then be affixed to the masking compound such that the sheet covers the doorway opening. The masking compound will dry into an elastic film. The masking compound holds the sheet securely in a weather resistant seal. The elastic film can be peeled cleanly from the doorway and also from the sheet. The ability to easily separate the elastic film and the sheet allows the sheet to be reused over the same or a different opening. Such reuse is particularly useful in painting a series of rooms with identical sized doorways, such as in a hotel.

An example of defining or dividing a space is to form a curtain wall by suspending the sheet from a ceiling such that the suspended sheet forms an enclosed area. For instance, the sheet could be suspended across the ceiling in the middle of a room or used to isolate the corner of a space. The isolation or division can be accomplished by applying the masking compound to a ceiling in the desired pattern and location including suspended ceilings and drop ceiling frames. Optionally, the masking compound can be applied to the corresponding locations on the floor and/or the walls. A sheet can then be affixed to the masking compound such that the sheet forms a temporary curtain wall. The masking compound will dry into an elastic film. The masking compound holds the sheet securely in a weather resistant seal. The elastic film can be peeled cleanly from the doorway and also from the sheet. The ability to easily separate the elastic film and the sheet allows the sheet to be reused in the same or a different space. The curtain wall will prevent the introduction of drywall dust, remodeling dust, paint overspray, fumes, etc. from entering the protected area.

1. A masking compound comprising a vulcanized rubber latex, at least one filler and aqueous ammonia.

2. The masking compound of claim 1 characterized in that a film layer of the compound dries to form an elastic rubber membrane.

3. A process for cleaning a surface, the process comprising the steps of:
applying a masking compound comprising a vulcanized rubber latex, at least one filler and aqueous ammonia to a surface to be cleaned;
allowing the masking compound to dry and form an elastic rubber membrane; and,
removing the elastic rubber membrane from the surface.

4. A process for masking a surface, the process comprising the steps of:
applying a masking compound comprising a vulcanized rubber latex, at least one filler and aqueous ammonia to a surface to be masked;
allowing the masking compound to dry and form an elastic rubber membrane, thereby forming a masked surface;
applying a coating to a surface to be coated in the vicinity of the masked surface; and,
removing the elastic rubber membrane from the substrate subsequent to coating the surface to be coated.

6. A method of isolating a space, the method comprising the steps of:
providing a first space and a second space, wherein the first space and second space are connected by an opening having at least one edge;
applying a masking compound along at least part of the edge of the opening or in close proximity to the opening;
affixing a sheet to the masking compound such that the sheet covers the opening, thereby isolating the first space from the second space.

7. A method of dividing a space, the method comprising the steps of:
providing a first space, wherein the first space is at least partially defined by a first surface and an opposing second surface;
applying a masking compound to at least part of the first surface;
affixing a sheet to the masking compound such that the sheet forms an at least partial barrier, thereby dividing the first space into a second space and a third space.
